(19) United States
(12) Patent Application Publication
(10) Pub. No.: US 2002/0010724 A1
(43) Pub. Date: Jan. 24, 2002

(54) Method and system for customer support

(76) Inventors: Brian L. Sterling, Hoquiam, WA (US); Alex M. Johnson, Olympia, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/751,303

(22) Filed: Dec. 28, 2000

Related U.S. Application Data
(60) Provisional application No. 60/174,071, filed on Dec. 30, 1999.

(51) Int. Cl. G06F 17/21

(52) U.S. Cl. 707/530; 707/513

(57) ABSTRACT

The present invention provides methods and systems for supporting the products and services of others, in the embodiments described herein. Customers access separate web sites with similar user interface designs and naming conventions so the customer is transparently transferred from a vendor's web site to a support service provider web site. User interface designs and naming conventions remain consistent through use of consistent HTML language and format.

### CROSS-REFERENCE TO RELATED APPLICATION

This application claims the benefit of U.S. Provisional Patent Application No. 60/174,071 filed Dec. 30, 1999; this provisional application is incorporated herein by reference in its entirety.

### TECHNICAL FIELD

This invention relates to methods and systems for offering customer support, and more particularly, in selected embodiments, to methods and systems for offering web site customer support on behalf of others.

### BACKGROUND OF THE INVENTION

Product support for software and other products and services traditionally includes telephone support in which customers can call a telephone support line, describe a problem, and attempt to get assistance. Product vendors often contract with service firms to offer such telephone support for their products. Such telephone support service is often unsatisfactory in that customers experience delays in getting access to customer support personnel and may have difficulty in accurately describing the nature of the problem they are experiencing. Offering telephone support is also relatively expensive for the product vendor.

Product vendors also offer support through help materials and other user documentation distributed with their products. These can be in the nature of printed customer manuals or, in the case of software products, help files stored electronically. While these materials can be of assistance, they often fall short of the customer's needs and do not allow the product vendor to easily update the support information after the product has been shipped.

Modernly, product vendors offer customer support on their web sites. Customers accessing the vendor's web site can request product and product support information. Computer networking environments, such as the Internet, offer mechanisms for delivering documents and other data between heterogeneous computer systems. The World Wide WEB (the “WEB”) is one such network. The WEB comprises a subset of Internet sites and supports a standard protocol for requesting and for receiving documents known as WEB pages. This protocol is known as the Hypertext Transfer Protocol, or “HTTP.” HTTP defines a high-level message passing protocol for sending and receiving packets of information between diverse applications. Details of HTTP can be found in various documents including T. Berners-Lee et al., Hypertext Transfer Protocol—HTTP 1.0, Request for Comments (RFC) 1945, MIT/LCS, May, 1996, which is incorporated herein by reference. Each HTTP message follows a specific layout. Further, each HTTP message that is a request (an HTTP request message) contains a universal resource identifier (a “URI”), which specifies a target network resource for the request. A URI is a Uniform Resource Locator (“URL”) or Uniform Resource Name (“URN”), or any other formatted string that identifies a network resource. The URI contained in a request message, in effect, identifies the destination machine for a message. URLs, as an example of URIs, are discussed in detail in T. Berners-Lee, et al., Uniform Resource Locators (URL), RFC 1738, CERN, Xerox PARC, Univ. of Minn., December, 1994, which is incorporated herein by reference.

FIG. 1 illustrates how, using a client/server model, a browser application enables users to navigate among nodes on the WEB network by requesting and receiving WEB pages. For the purposes of this application, a WEB page is any type of document that contains an “<HTML>” statement. That is, a document that qualifies as a WEB page abides by the HTML format. Thus, a WEB page is also referred to as an HTML page. The HTML format is a document markup language, defined by the Hypertext Markup Language (“HTML”) specification. HTML defines tags for specifying how to interpret the text and images that are stored in an HTML page. For example, there are HTML tags for defining paragraph formats, indicating boldface and underlined text, adding images, and formatting and aligning text with respect to images. HTML tags appear between angle brackets, for example, <HTML>. Further details of HTML are discussed in T. Berners-Lee and D. Connolly, Hypertext Markup Language-2.0, RFC 1866, MIT/W3C, November, 1995, which is incorporated herein by reference.

In FIG. 1, a WEB browser application 2 is shown executing on a client computer system 1, which communicates with an HTTP server computer system 3 by sending and receiving HTTP packets (messages). The WEB browser application 2 requests HTML pages from other locations on the network to browse (display) what is available at these locations. This process is known as “navigating” to sites on the WEB network. In particular, when the WEB browser application 2 “navigates” to a new location, it requests a new page from the new location (e.g., server computer system 3) by sending an HTTP-request message 4 using any well-known underlying communications wire protocol. The new location may be specified as the value of a “link” field, which, when selected, causes the request for the new page. The HTTP-request message 4 includes a URI field 5, which specifies the target network location for the request. When the server computer system specified by URI 5 (e.g., the server computer system 3) receives the HTTP-request message, it deconstructs (parses) the message packet and processes the request. When appropriate, the server computer system 3 constructs a return message packet directed to the source location that originated the message (e.g., the client computer system 1) in the form of an HTTP-response message 6. In addition to the standard features of an HTTP message, the HTTP-response message 6 contains the requested HTML page 7. When the HTTP-response message 6 reaches the client computer system 1, the WEB browser application 2 extracts the HTML page 7 from the message. The WEB browser application 2 then parses and interprets (executes) the HTML code in the page, as specified by the HTML tags, to display the page on a display screen of the client machine 1.

While web-based support of this type can be helpful to the customer, product vendors often find it difficult or expensive to offer quality web-based support assistance. Developing a resource of this type is often outside the core competency of the product vendor.

### SUMMARY OF THE INVENTION

The present invention includes improved methods and systems for supporting the products or services of others. In the embodiments described herein, customers access a vendor's web site and can request product support on the site. When support is requested, the customer is “transparently” transferred to a separate third party support service provider site, where a knowledge base developed by the support service provider and support tools specific to the vendor's product or services are available to the customer. The customer can move seamlessly back and forth from the third party support site to the vendor's site. The vendor web pages and support service provider web pages are preferably named in a consistent manner to increase the transparency of the switches from one web site to the other.

### BRIEF DESCRIPTION OF THE DRAWINGS

FIG. 1 illustrates how, using a client/server model, a browser application enables users to navigate among nodes on the WEB network by requesting and receiving Web pages.

FIG. 2 is a schematic diagram of an embodiment of the present invention.

FIG. 3 is a screen print showing a vendor web page in accordance with one embodiment of the present invention.

FIG. 4 is a screen print showing a support service provider's web page for the embodiment shown in FIG. 3.

FIG. 5 is a screen shot for a further support service provider web page in accordance with the embodiment illustrated in FIGS. 3 and 4.

FIG. 6 is a further support vendor web page for use in the embodiment of FIGS. 35.

FIG. 7 is a schematic illustration showing one embodiment for creating support vendor web pages.

FIG. 8 is a schematic illustration for the embodiment of FIG. 7.

FIG. 9 is a flow diagram illustrating the method and system of the present invention per the embodiment described herein.

FIG. 10 is a flow diagram illustrating the method and systems of the present invention per an embodiment described herein.

FIG. 11 is a screen shot showing a vendor web page in accordance with one embodiment of the present invention.

FIG. 12 is a screen shot showing a support service provider web for the embodiment shown in FIG. 11.

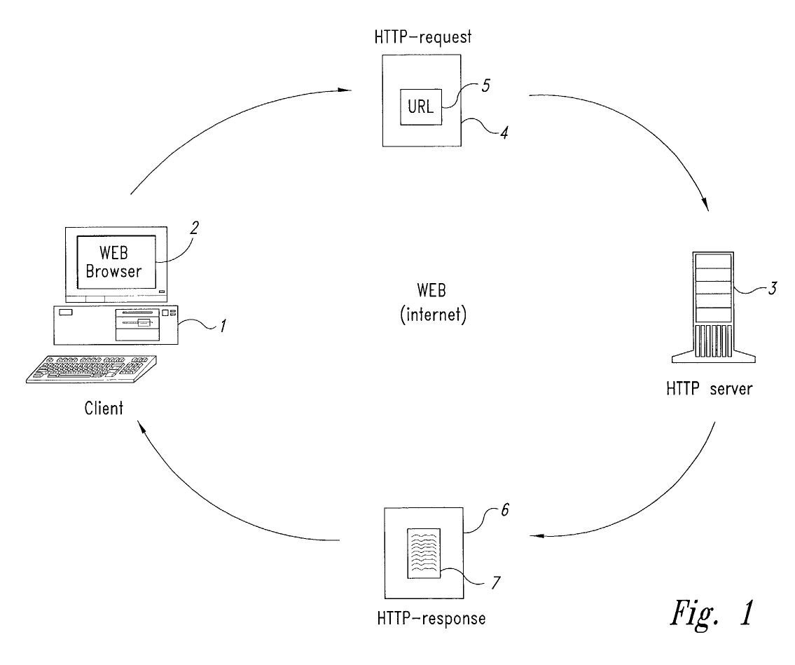

### DETAILED DESCRIPTION OF THE INVENTION

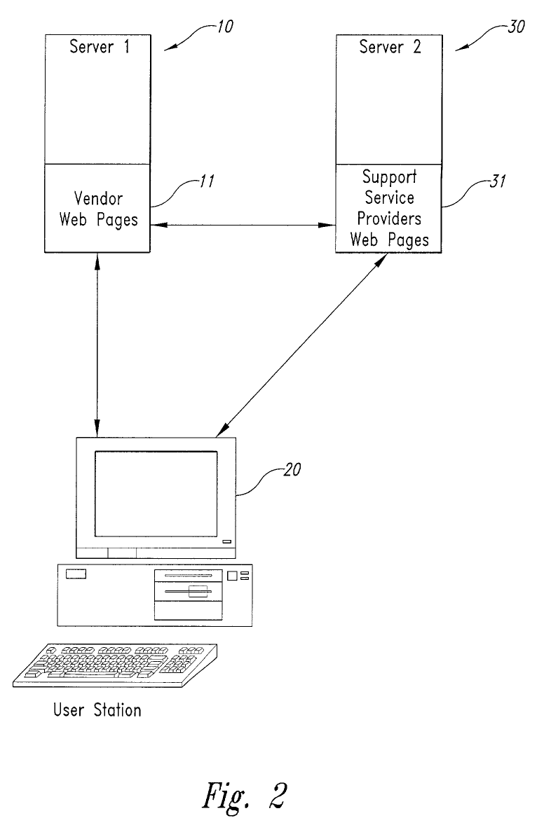

The methods and systems of the present invention allow a customer to access a product vendor's web site and request support information from the site. In response to the request, the customer is transparently directed to a third party support web site, developed and maintained separately from the vendor's web site. By employing the methods and techniques of the present invention, the customer can access this support information without losing the user experience of being on the vendor's web site. The customer can move seamlessly back and forth from the vendor's web site to the third party support site, yet is actually accessing separate sites, as shown schematically in FIG. 2. As shown in FIG. 2, a customer uses a user station 20 to access a network such as the world wide web using a modem (not shown) linked to an Internet service provider (not shown) as is known. As described in more detail below, the customer can then access vendor web pages 11 located on a first server 10 and support service provider web pages 31 located on a second server 30.

The methods and systems of the present invention apply equally to customer support for products or services. Thus, references herein to “products” or “product support” encompass both product and service offerings and support therefor.

The methods and systems of the present invention are advantageous in that they allow third parties with specialized expertise in the area of customer support to develop and maintain customer support tools and knowledge bases on a web site. The resulting system is convenient and cost effective for the vendor, the third party support supplier and the customer. From the customer's standpoint, they need only access the product vendor's web site to obtain all available information concerning the product and product support. In embodiments with consistent user interfaces, the customer's knowledge and familiarity of the vendor's web site allows it to more easily and effectively use the support web site, and vice versa. From the third party support service standpoint, customers needing the support information are easily directed to the information via the vendor's web site. User interface familiarity also assists in allowing easy access and use of the support information. Finally, from the product vendor's standpoint, it is able to offer the customer a seamless user experience. Support information can be developed by a service specializing in this area, yet appear to the vendor's customers as if it is coming from the vendor. Thus, customer goodwill flowing from positive results of using the support database flow to the product vendor.

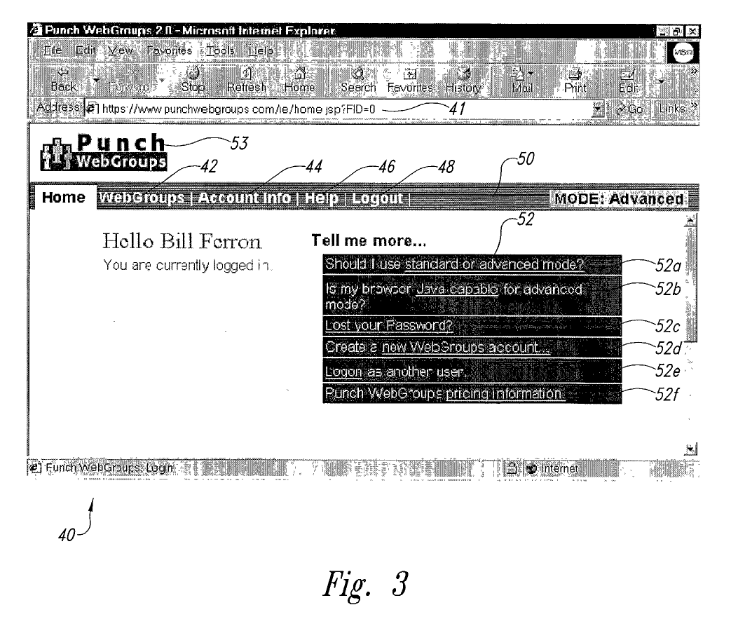

One embodiment of the present system is shown as implemented for vendor Punch WebGroups. In FIG. 3, a user has logged in to the Punch WebGroups' web site at www.punchwebgroups.com. The user's computer is accessing the Punch WebGroups' Home page 40 and is presented with options to proceed to web pages for WebGroups 42, Account Info 44, Help 46 and Logout 48 by selecting commands located across a menu bar positioned in the upper region of the screen. A rectangular region 52 in the center of the screen provides a number of links 52a-52f to other locations on the Punch WebGroup's web site and the support service provider's web site, as will be explained below. The vendor's logo 53 is displayed in the upper-left corner of the page.

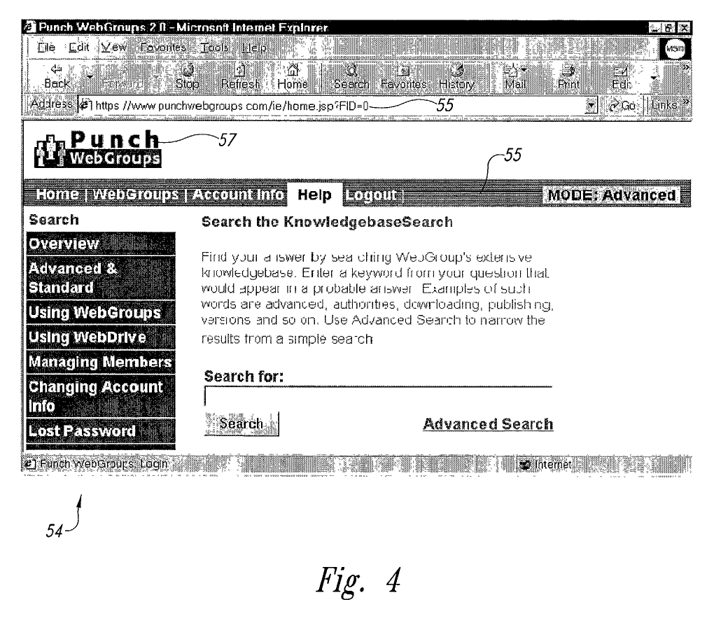

When the user selects the Help option from the menu bar, the user's computer is directed toward the initial Help page 54 shown in FIG. 4. As can be seen by comparing FIG. 3 and FIG. 4, by all appearances the user remains on the same web site. The user interface of the Home page 40 is consistent with that of the Help page 54. A menu bar 55 is displayed corresponding to menu bar 50 on vendor page 40, as is the vendor's logo 57. The selections in the bar 55 have been linked to the appropriate pages on the vendor's web site. Also, the web browser continues to display the Home page address 41, 55 when viewing the Home page and the Help page. As previously indicated and as seen in FIG. 2, the Help page and other web pages for providing customer support are developed by and located on a server 30 for a third party support service provider. In the present example, the support pages are maintained by SafeHarbor.com Inc., assignee of the present invention.

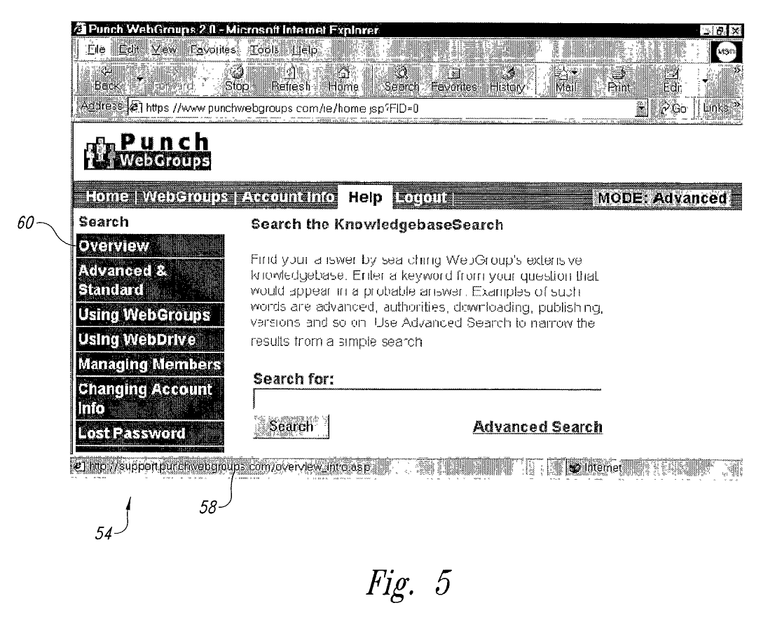

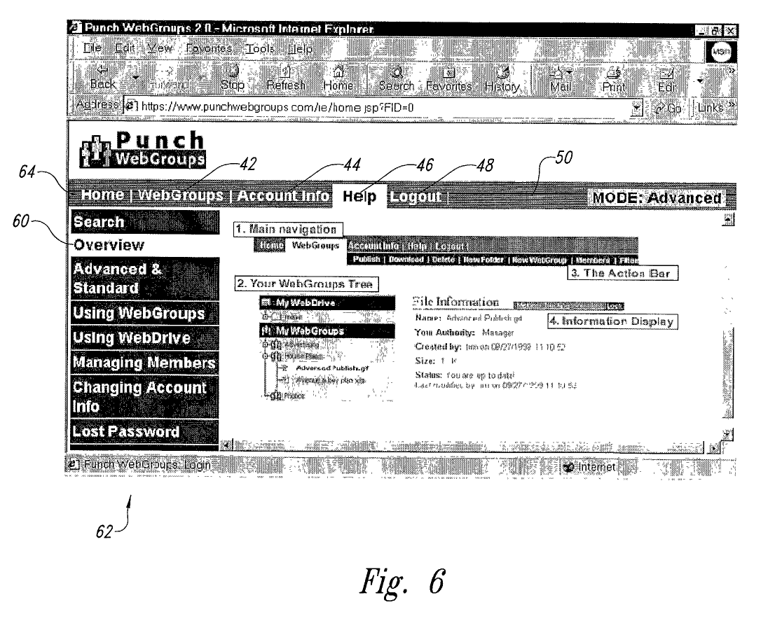

In the present embodiment, the support pages are named consistent with the vendor's web pages. For example, the Overview page 62 accessible from the Help page 54 is named “http://support.punchwebgroups.com/overview_intro.asp” 58, as shown in FIG. 5. In FIG. 5, the user has moved the mouse cursor (not shown) over the Overview command 60 along the left side of the Help page 54. In the browser program being used in this example (Microsoft Internet Explorer® version 5), the web page address for the Overview page 62 appears at the bottom of the web browser 58. When the user selects the Overview command 60, the Overview page 62 is displayed as shown in FIG. 6. Again, the Overview page preferably has a user interface consistent with the vendor's web site pages so that the user continues to have a consistent experience whether accessing the vendor's web pages or the corresponding support service provider's web pages.

While on the support service provider's web site, the user may access the vendor's Home page 40 by accessing the Home command 64 from the menu bar 50 included on the support service provider's web pages. Similarly, other portions of the vendor's web site such as WebGroups 42, Account Info 44 and Logout 48 may be accessed just as if on the vendor's site.

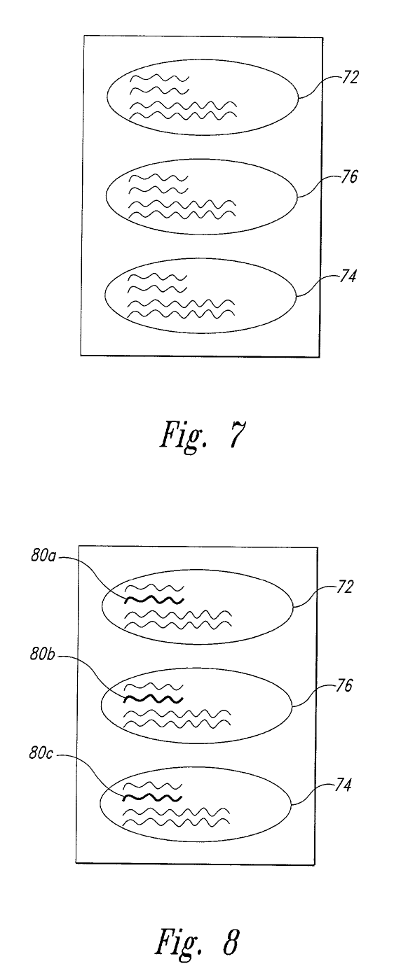

FIG. 7 illustrates schematically one method for creating the service provider web pages described above. Developers for the service provider can take the HTML code for a representative vendor web page and use it to efficiently develop support service provider web pages. A representative page 70 is analyzed to determine those portions of the code 72, 74 that define the user interface of the vendor's web page. These portions are copied for use in the service provider's page. The portions specific to the vendor's page content 76 are identified and replaced in the new web page with the service provider's content 78, as shown in FIG. 8. The page is then reviewed for any web site addresses 80a-80c which are then corrected as appropriate to refer either to the vendor's web pages or the service provider's web pages. This method for creating the service provider web pages may further include the ability to dynamically adjust such that changes to the representative page 70 of the vendor web page are automatically incorporated into the service providers' content 78. A format processor may be used to provide dynamic updates. Thus, upgrades to the look of the vendor's web page are automatically transferred to the service providers' web page.

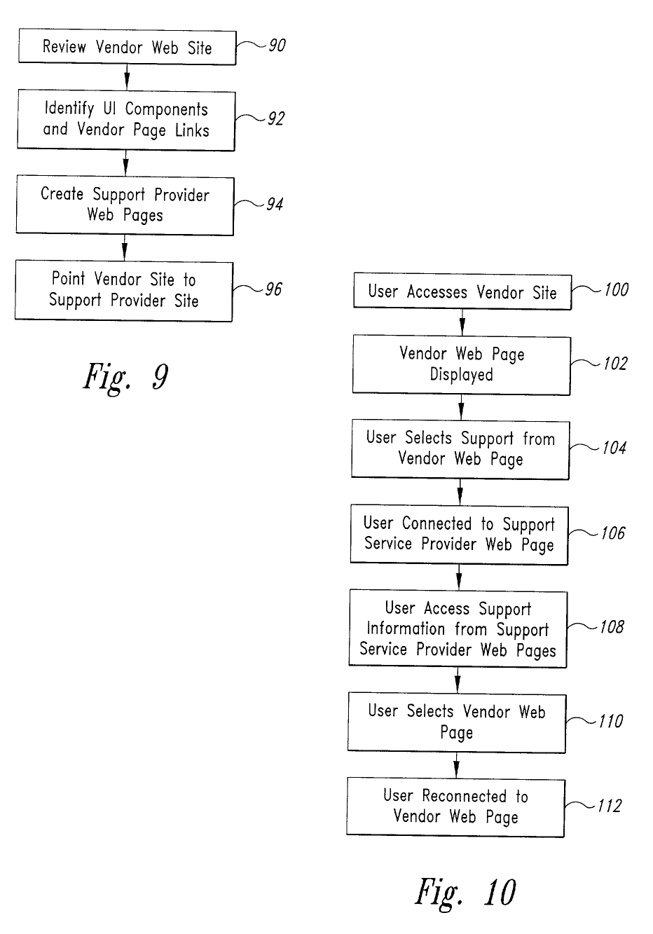

FIG. 9 reviews the basic steps implemented by the methodology implemented in the embodiments of the methods and systems described herein. The vendor web site is reviewed 90 and the information from that review is used to identify the user interface components and vendor page links that will be used for the support provider web pages 92. Typically, these will include any menu bars and other navigational links used on vendor web pages, plus vendor logo displays and other graphics that may be used on the vendor's web pages. Once these are identified, the support provider web pages are created. As noted above, this can be done using copies of the HTML code from vendor web pages. The actual content of the knowledge base used in the support pages can be developed using information available from the vendor or developed specifically for this purpose, in known manners. Methodology for developing this knowledge base is beyond the scope of the present invention. As indicated above, it is preferred that the support web pages be named to maximize the transparency of the shift from the vendor web site to the support provider web site, as this information may be apparent to the user at various locations depending upon the web browser being employed. Thus, for a vendor site located at “www.vendor.com” for example, the support pages can be named and located at web addresses, such as “www.support.vendor.com” or “www.help.vendor.com.” As discussed above, these support pages will actually be located on the server for the support service provider. Using a naming convention of this type, however, will be helpful. Once the support web pages have been created, the vendor web site must be modified to link users to the support provider web site when they request support pages 96.

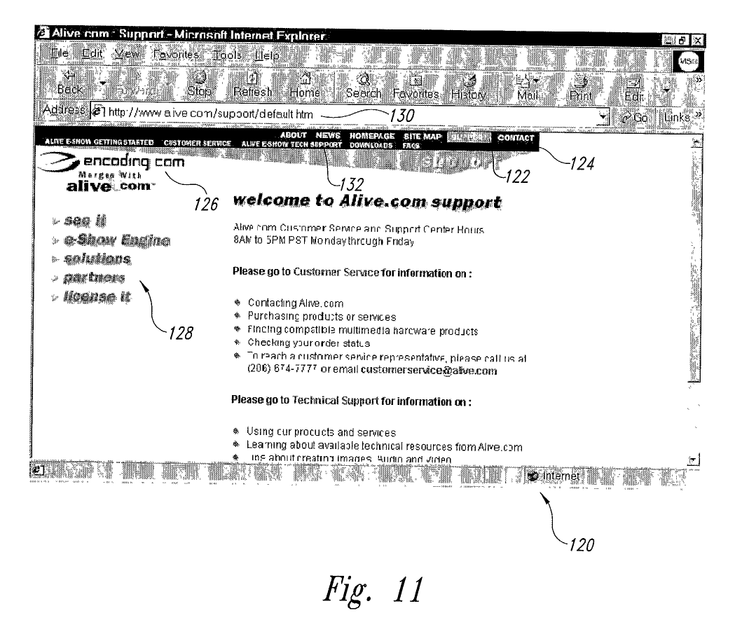

In a typical user interaction under the system, the user accesses a vendor web site 100 as shown in FIG. 10. A vendor web page 102, such as the vendor's home page, will be displayed on the user's machine. The user will then select a support option or command from the vendor web page 104. Upon that selection, the vendor web page will link the user to the support service provider web page 106 which is operating on a separate server. The user can then access support information from the support service provider web pages 108. From the support service provider web pages, the user may optionally select a command which is linked to information on the vendor web page 110. Upon that selection, the user will be reconnected to the vendor web page 112. As discussed, the user interface and web page names for the vendor web site and the support service provider web site are preferably selected so that it is transparent to the user that he or she is going from one web site to the other.

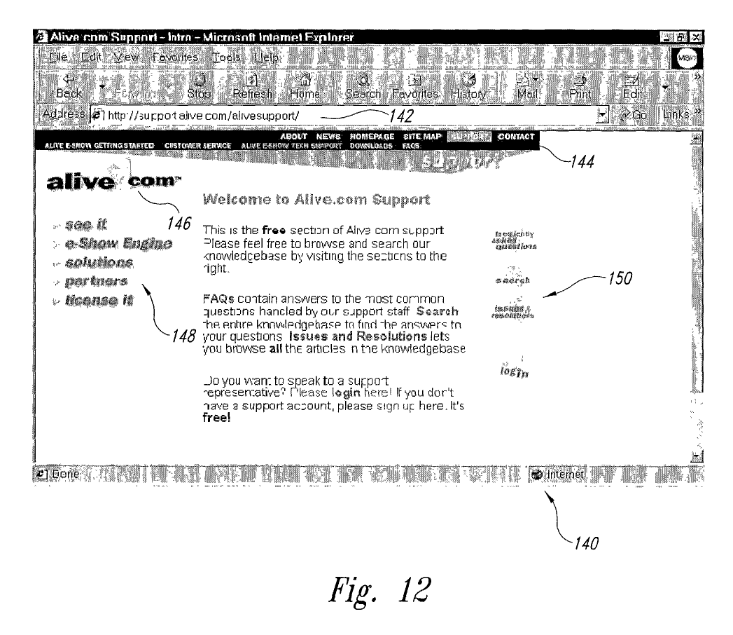

FIGS. 11 and 12 illustrate another embodiment of the invention. FIG. 11 shows a customer web browser accessing a vendor's web page 120 located at “http://alive.com/support/default.” In this embodiment, some support-related web pages are maintained by the vendor on the vendor's web site, such as the one shown in FIG. 11 which is accessed when a customer selects “support” 122 from a menu bar 124 at the top of the web page. On the left side of the page is a display 126 with the vendor's logo and a group of menu selections 128. The customer's web browser displays the web page address 130 on its web address display area. One of the selections available to the customer from this vendor support page is “Tech-Support” 132.

FIG. 12 shows a customer web browser accessing a support service provider web page 140 to which the customer is linked when the customer selects Tech-Support 132 from the vendor web page 120. This web page 140 is located at “http://support.alive.com/alivesupport” as shown in the browser web address display area 142. As can be seen by comparing FIGS. 11 and 12, the support service provider web page 140 includes a menu bar at the top of the page corresponding to that on the vendor's web page. Each command has been linked back to the appropriate vendor web page. A vendor logo 146 and a group of menu selections appear on the left hand portion of the page, paralleling those (126, 128) on the vendor's page 120. The support service provider's content 150 appears in the center region of the screen.

The HTML code for the web pages shown in FIGS. 11 and 12 is shown in Table 1 and Table 2 below. In Table 2, the portions of the HTML code corresponding to Table 1 are shown in italics.

It will be apparent to those of skill in the art that the present inventions and methods can be carried out in other embodiments that remain within the spirit of the invention. Thus, the present invention is not limited by the foregoing but is defined by the claims attached and as may be amended.

[image]

[image]

[image]

[image]

[image]

[image]

[image]

[image]

[image]

[image]

[image]

[image]

[image]

[image]

[image]

[image]

[image]

[image]

[image]

1. A method in a computer system network environment for providing support information to vendor customers via a third party support service provider from a host web page, the support information provided transparently such that a consistent web page format of the host site is maintained, the method comprising the steps of:
determining a HTML code for a representative host web page;
analyzing the HTML code from the representative page to determine portions of the HTML code that define a user's interface with the host web page;
copying the determined portions of the HTML code for use in a third party support service provider's page;
identifying portions of the HTML code specific to the host web page;
replacing identified portions of the HTML code specific to the host web page with the service provider's content; and
modifying the host web site to include a link to the support provider web site when support information is requested.

2. The method for providing support information to vendor customers of claim 1 further including reviewing a web page address of the host and editing the support service provider's web page address as appropriate to maintain consistent naming with the host's web page address.

3. The method for providing support information to vendor customers of claim 1 wherein the step of replacing identified portions of the HTML code specific to the host web page with the service provider's content is performed by a format processor at the time of the support information request.

4. A method for providing support information to vendor customers, comprising the steps of:
providing a vendor web site with vendor web pages including selected user interface features;
providing a support service provider web site with support service provider web pages including user interface features corresponding to the selected user interface features of the vendor web pages; and
linking a support selection on the vendor web site to the support service provider web site so that when customers make a support selection it will be transparently linked to the support service provider web page.

5. The method according to claim 4, further including the steps of:
providing links on the support service provider web pages that return users to the vendor web site.

6. The method of claim 4, further including the step of naming the support service provider web pages to include the vendor web page name.

7. A computer-implemented system for transparently providing support via an independent support provider web site through links provided on a host web site, comprising:
a host web site accessible via a computer networking system;
at least one of a host web page defined by HTML language in a specific HTML format;
a support service web site independent of the host web site, the support service web site accessible via the computer networking system;
a link on the host web page connecting the host web site to the support service web site;
at least one of a support service web page accessible through the link;
relevant support information provided on the support service web page, the relevant support information presented in a consistent format to the host web page as defined by the host web page HTML language in the specific HTML format.

8. The computer-implemented system of claim 7 wherein the support service web page includes visual displays from the vendor web site.

9. The computer-implemented system of claim 7 wherein the support service web page includes a uniform resource locator consistent with the vendor web site uniform resource locator.

10. The computer-implemented system of claim 7 further including a link on the support service web page connecting the support service web site back to the host web site.
